(19) United States
(12) Patent Application Publication
(10) Pub. No.: US 2026/0228751 A1
(43) Pub. Date: Aug. 6, 2026

(54) Product Offering Based on a Support Call

(71) Applicant: Dell Products L.P., Round Rock, TX (US)

(72) Inventors: Ophir Buchman, Raanana (IL); Yevgeni Gehtman, Modi'in (IL); Omer Aharony, Newton, MA (US)

(21) Appl. No.: 19/046,285

(22) Filed: Feb. 5, 2025

(51) Int. Cl. G06Q 30/015; G06F 8/61

(52) U.S. Cl. CPC G06Q 30/015; G06F 8/61

(57) ABSTRACT

A system can identify an issue with a computing device based on support call data obtained during a support call. The system can determine that a current configuration of the computing device omits a functionality, which prevents fixing the issue with the computing device using the current configuration of the computing device. The system can provide information about the functionality to a data store that comprises identifications of functionalities, to produce an identifier of a product that comprises the functionality, wherein the current configuration of the computing device omits the product, and wherein the computing device is determined to be able to install the product. The system can store the identifier of the product that comprises the functionality. The system can initiate installation of the product to the computing device.

### BACKGROUND

Computers can experience problems, and a cause of a problem can be identified, such as in a support call between a user of the computer and a vendor of the computer. It can also be that users of computers can be offered products (e.g., applications) that can be used with those computers.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can identify an issue with a computing device based on support call data obtained during a support call. The system can determine that a current configuration of the computing device omits a functionality, which prevents fixing the issue with the computing device using the current configuration of the computing device. The system can provide information about the functionality to a data store that comprises identifications of functionalities, to produce an identifier of a product that comprises the functionality, wherein the current configuration of the computing device omits the product, and wherein the computing device is determined to be able to install the product. The system can store the identifier of the product that comprises the functionality. The system can initiate installation of the product to the computing device.

An example method can comprise identifying, by a system comprising at least one processor, a problem with a computer. The method can further comprise determining, by the system, that a current configuration of the computer omits a functionality, which prevents fixing the problem with the computer while using the current configuration of the computer; inputting, by the system, information about the functionality to a data store that comprises identifications of functionalities, resulting in an output from the data store comprising an identifier of a module that comprises the functionality, wherein the current configuration of the computer omits the module, and wherein the computer is capable of having the module installed. The method can further comprise storing, by the system, the identifier of the module that comprises the functionality.

An example non-transitory computer-readable medium can comprise instructions that, in response to execution, cause a system comprising a processor to perform operations. These operations can comprise identifying an issue with computing equipment. These operations can further comprise determining that a current configuration of the computing equipment omits a functionality that is able to fix the issue with the computing equipment using the current configuration of the computing equipment. These operations can further comprise, based on information about the functionality, querying a data store that comprises identifications of functionalities, resulting in return of an identifier of a product that comprises the functionality, wherein the current configuration of the computing equipment omits the product, and wherein the computing equipment is configured to be able to install the product.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate product offering based on a support call, in accordance with an embodiment of this disclosure;

FIG. 2 illustrates an example that can facilitate product offering based on a support call, in accordance with an embodiment of this disclosure;

FIG. 3 illustrates another example that can facilitate product offering based on a support call, in accordance with an embodiment of this disclosure;

FIG. 4 illustrates another example that can facilitate product offering based on a support call, in accordance with an embodiment of this disclosure;

FIG. 5 illustrates an example process flow that can facilitate product offering based on a support call, in accordance with an embodiment of this disclosure;

FIG. 6 illustrates another example process flow that can facilitate product offering based on a support call, in accordance with an embodiment of this disclosure;

FIG. 7 illustrates another example process flow that can facilitate product offering based on a support call, in accordance with an embodiment of this disclosure;

FIG. 8 illustrates another example process flow that can facilitate product offering based on a support call, in accordance with an embodiment of this disclosure;

FIG. 9 illustrates another example process flow that can facilitate product offering based on a support call, in accordance with an embodiment of this disclosure;

FIG. 10 illustrates another example process flow that can facilitate product offering based on a support call, in accordance with an embodiment of this disclosure; and

FIG. 11 illustrates an example block diagram of a computer operable to execute an embodiment of this disclosure.

### DETAILED DESCRIPTION

### Overview

The present techniques can generally relate to areas such as helping sales representatives identify new leads from support calls. This can facilitate turning support interactions into sales opportunities.

Consider a case where a user of a computer makes a support call to a vendor of that computer. In this scenario, a call topic prediction mechanism can identify the user's issue, and provide at least one resolution step.

It can be that none of the available resolutions resolves the specific user case do to missing functionality or product limitations with the computer.

While the vendor can have a different product (e.g., either through a direct sale or a third-party channel sale), it can be that the vendor support agent on the support call cannot offer this different product because the support agent is not a salesperson. In this example, it can be that the support agent is unable to resolve the user's issue, and leaves the user unsatisfied, which can lead to churn (where the user switches from the vendor to a different vendor).

The present techniques can address these problems. There can be scenarios where the issue cannot be resolved based on the computer's current configuration, but an upsell opportunity can avoid user churn. In such a scenario, details of the missing functionality can be provided to a system (e.g., a dedicated system) that maintains a list of functionalities offered by different products.

These functionalities can be offered by the vendor's products, and also by products from different vendors.

Where this system identifies a product that offers the missing functionality, a salesperson can be engaged to join the support call or to engage the user directly.

The present techniques can be implemented to facilitate an automatic generation of an upsell opportunity during a support call's in-call phase. The present techniques can also be implemented to facilitate a vendor-direct and vendor-channel feature comparison according to a metric of a best solution and/or a metric of a best profit opportunity.

Prior approaches generally involve user-reactive engagement to a sales agent, or a support agent proactively reporting to a sales agent.

In an example according to the present techniques, a user can experience data loss due to a system crash, resulting in a loss of important files. The present techniques can facilitate identifying the issue during a support call and determining that a current configuration of the user's computer lacks a reliable backup solution. A data store can be queried to identify a backup product that is compatible with the user's computer, and that can be installed upon the user's computer. The support agent can then provide the user with information about the backup software, and assist with the ordering, installation, and configuration of the backup software. This can ensure that the user's data is regularly backed up, which can help prevent against future data loss, and improve data availability.

### Example Architectures, etc.

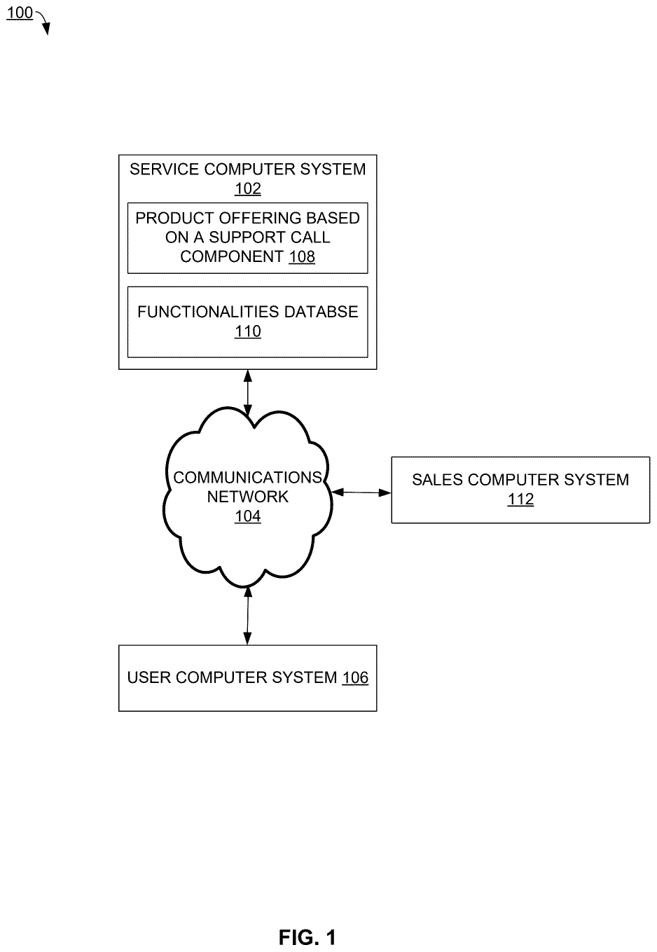

FIG. 1 illustrates an example system architecture 100 that can facilitate product offering based on a support call, in accordance with an embodiment of this disclosure.

System architecture 100 comprises service computer system 102, communications network 104, user computer system 106, and sales computer system 112.

Service computer system 102 comprises product offering based on a support call component 108 and functionalities database 110.

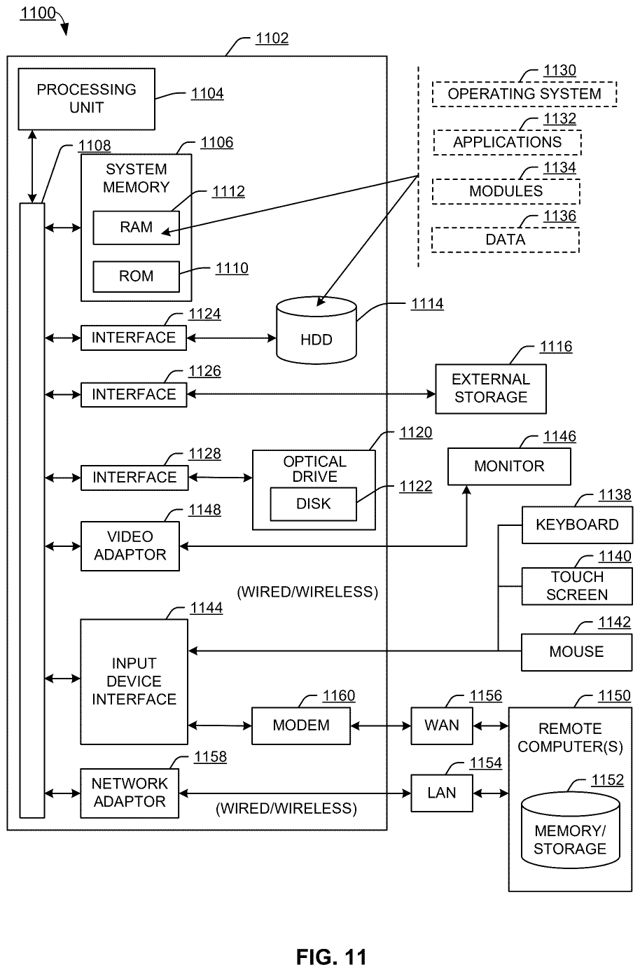

Each of service computer system 102, user computer system 106, and/or sales computer system 112 can be implemented with part(s) of computing environment 1100 of FIG. 11. Communications network 104 can comprise a computer communications network, such as the Internet.

User computer system 106 can be experiencing an issue or a problem with its operation. As part of fixing this, a support call can be made from a user associated with user computer system 106 to a support agent associated with service computer system 102. As this problem is investigated, it can be determined that a resolution involves a functionality that is not present on service computer system 102. Functionalities database 110 can be accessed to identify at least one product that is suitable for user computer system 106 and that offers this product. A notification of this can be made to sales computer system 112, which can be used to offer the product to a user of user computer system 106. Product offering based on a support call component 108 can facilitate this.

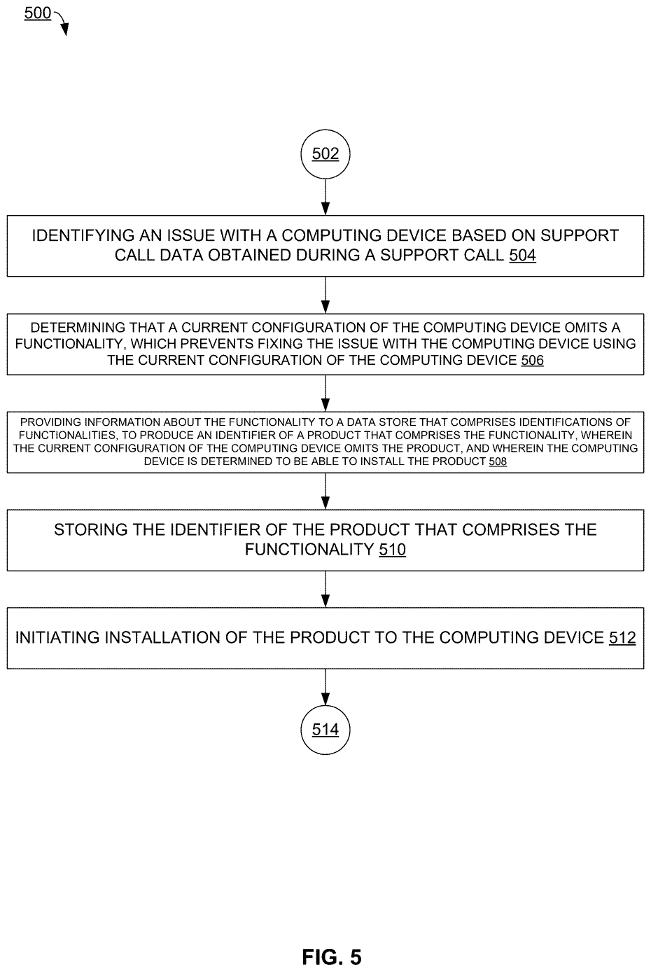

In some examples, product offering based on a support call component 108 can implement part(s) of the process flows of FIGS. 5-10 to implement product offering based on a support call.

It can be appreciated that system architecture 100 is one example system architecture for product offering based on a support call, and that there can be other system architectures that facilitate product offering based on a support call.

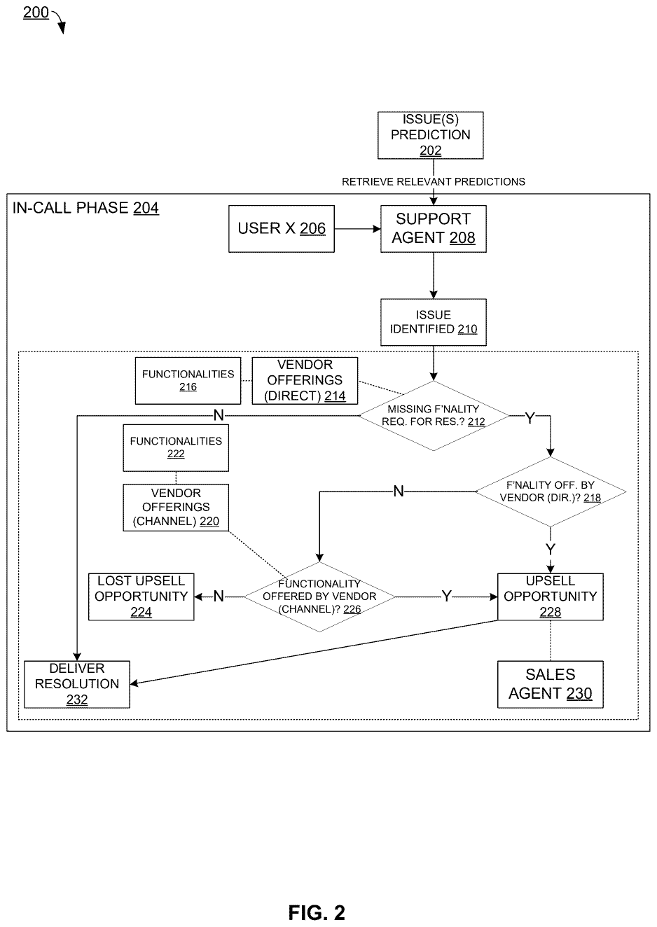

FIG. 2 illustrates an example 200 that can facilitate product offering based on a support call, in accordance with an embodiment of this disclosure. In some examples, part(s) of example 200 can be implemented by part(s) of system architecture 100 of FIG. 1 to facilitate product offering based on a support call.

Example 200 comprises issue(s) prediction 202, in-call phase 204, user X 206, support agent 208, issue identified 210, missing functionality required for resolution? 212, vendor offerings (direct) 214, functionalities 216, functionality offered by vendor (direct)? 218, vendor offerings (channel) 220, functionalities 222, lost upsell opportunity 224, functionality offered by vendor (channel)? 226, upsell opportunity 228, sales agent 230, and deliver resolution 232.

Based on system architecture 200, during an in-call phase of a support call, where a determination is made that a problem with a computer is due to missing functionality on that computer, and where it is determined that there is a suitable product offering that offers that missing functionality, then a sales agent can be notified so as to offer that product.

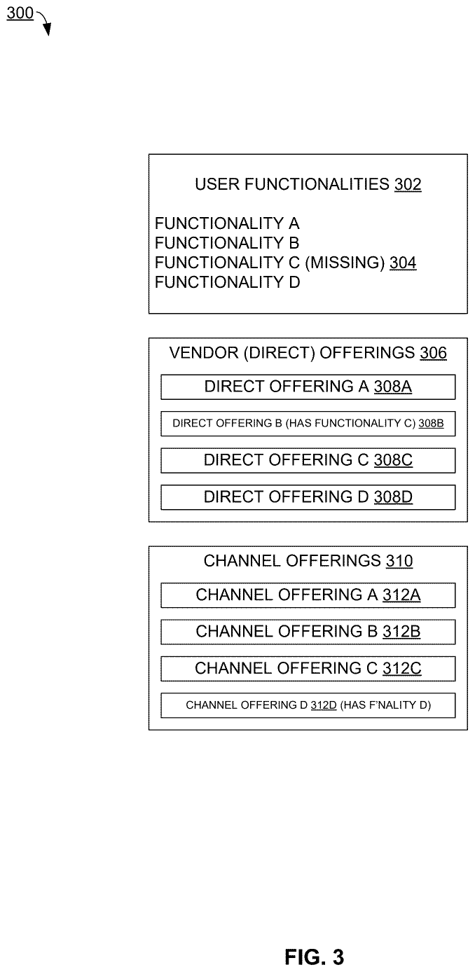

FIG. 3 illustrates another example 300 that can facilitate product offering based on a support call, in accordance with an embodiment of this disclosure. In some examples, part(s) of example 300 can be implemented by part(s) of system architecture 100 of FIG. 1 to facilitate product offering based on a support call.

Example 300 comprises user functionalities 302, functionality C (missing) 304, vendor (direct) offerings 306, direct offering A 308A, direct offering B (has functionality C) 308B, direct offering C 308C, direct offering D 308D, channel offerings 310, channel offering A 312A, channel offering B 312B, channel offering C 312C, and channel offering D 312D (has functionality D).

Example 300 illustrates how a product (or computer) can comprise multiple functionalities, how a particular functionality can be omitted from a computer, and how there can be multiple available products for that computer that might offer the particular functionality.

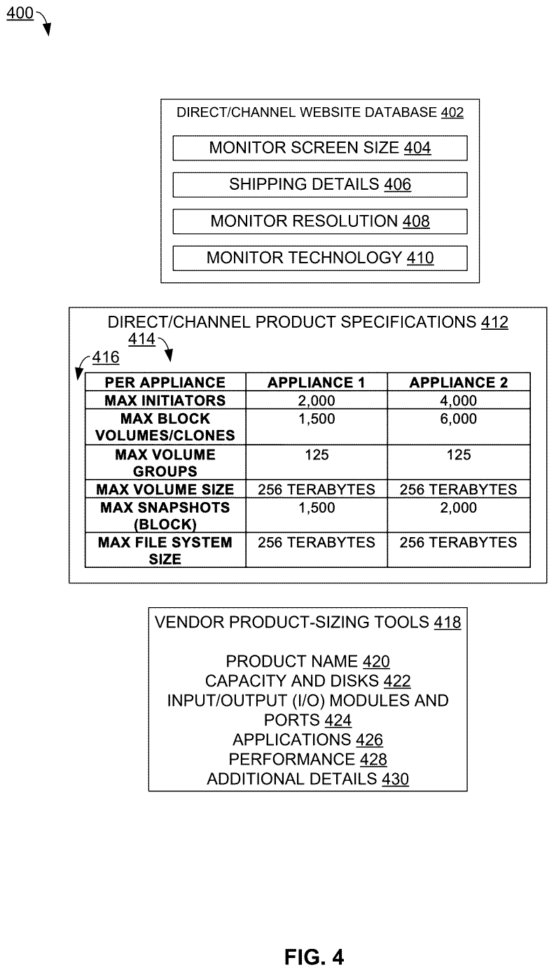

FIG. 4 illustrates another example 400 that can facilitate product offering based on a support call, in accordance with an embodiment of this disclosure. In some examples, part(s) of example 400 can be implemented by part(s) of system architecture 100 of FIG. 1 to facilitate product offering based on a support call.

Example 400 comprises direct/channel website database 402, which comprises monitor screen size 404, shipping details 406, monitor resolution 408, and monitor technology 410.

Example 400 also comprises direct/channel product specifications 412, which comprises columns 414 and rows 416.

Example 400 also comprises vendor product-sizing tools 418, which comprises product name 420, capacity and disks 422, input/output (I/O) modules and ports 424, applications 426, performance 428, and additional details 430.

Example 400 illustrates data sources that can be accessed to determine whether a particular product offers a particular functionality.

The present techniques can use the information of example 400 to identify whether particular products offer specific functionalities by parsing various data sources, as follows:

Data Collection: collect data from multiple sources, such as product specifications, user manuals, online reviews, and vendor databases.

Data Parsing: utilize natural language processing (NLP) techniques to parse the collected data. These techniques can extract relevant information about product functionalities, compatibility, and performance metrics.

Functionality Identification: the parsed data can be analyzed to identify specific functionalities offered by different products. For example, it can be determined whether a product includes features like increased memory capacity, enhanced graphics processing, or improved battery life.

Data Store Update: the identified functionalities can be stored in a centralized data store, which can maintain a comprehensive list of product features and their corresponding products.

Query and Recommendation: when a support call identifies a missing functionality in a user's computer, the data store can be queried to find products that offer the required functionality. A suitable (or most suitable) product can then be recommended to the user, based on compatibility and performance criteria.

### Example Process Flows

FIG. 5 illustrates an example process flow 500 that can facilitate product offering based on a support call, in accordance with an embodiment of this disclosure. In some examples, one or more embodiments of process flow 500 can be implemented by product offering based on a support call component 108 of FIG. 1, or computing environment 1100 of FIG. 11.

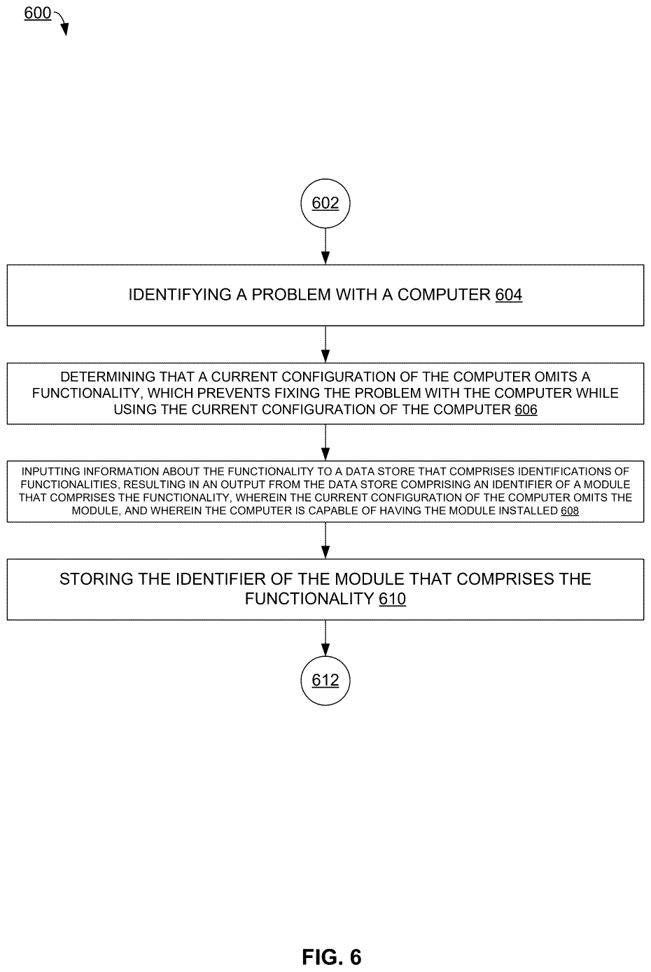

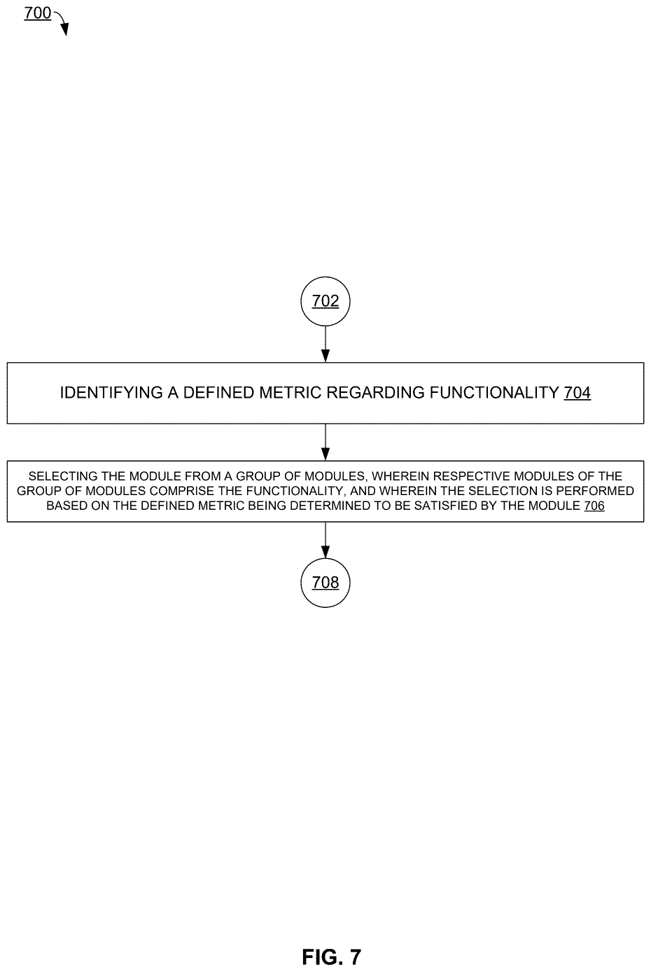

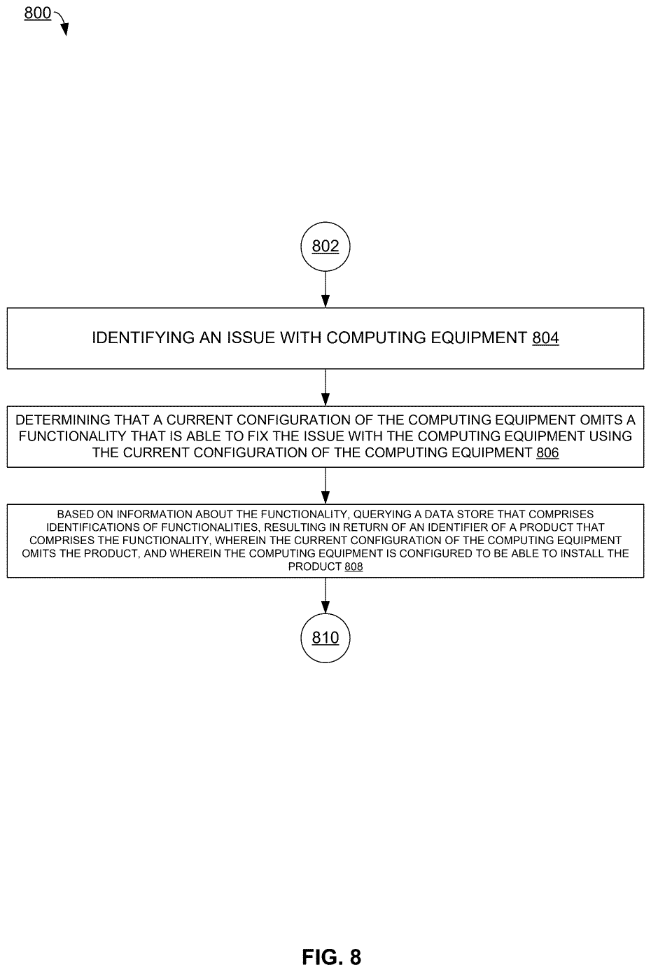

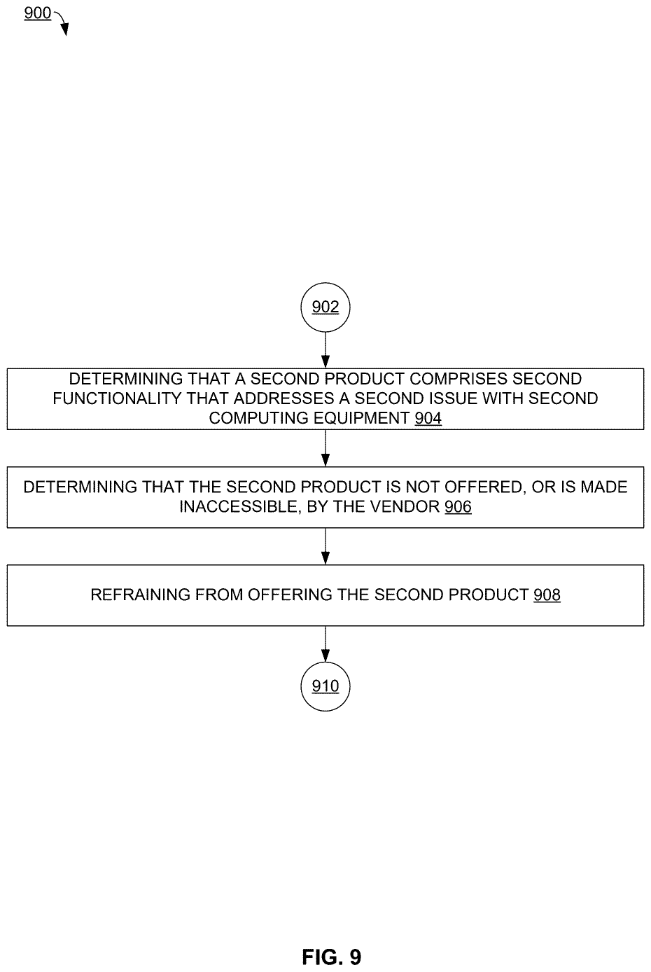

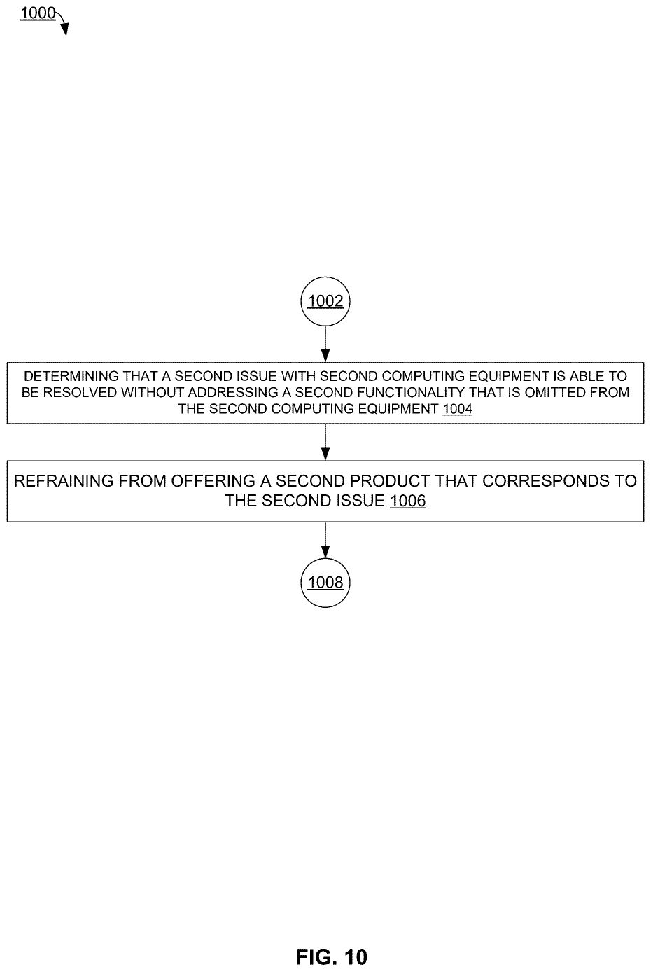

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts identifying an issue with a computing device based on support call data obtained during a support call. This can comprise identifying the use based on information received from a user (e.g., user X 206 of FIG. 2) on the support call. In other examples, this can be implemented by retrieving relevant predictions from issue(s) prediction 202 of FIG. 2.

In some examples, the support call is between a user associated with the computing device and a support agent, and operation 504 comprises making correction data indicative of the product that comprises the functionality available to a user device associated with the user by a sales agent device associated with a sales agent, wherein the user device is at least one of the computing device or another user device other than the computing device. That is, a sales agent can be informed of the opportunity stemming from the support call.

In some examples, the making of the correction data indicative of the product that comprises the functionality available to the user device occurs during the support call. In some examples, the making of the data indicative of the product that comprises the functionality available to the user device occurs in a separate process that occurs in parallel to the support call. That is, there can be examples where the sales agent is looped into the support call, and there can be other examples where the sales agent communicates with the user outside of (e.g., after) the support call.

After operation 504, process flow 500 moves to operation 506.

Operation 506 depicts determining that a current configuration of the computing device omits a functionality, which prevents fixing the issue with the computing device using the current configuration of the computing device. That is, the user's computer can be experiencing a problem, and fixing the problem can be inhibited because the computer is missing certain functionality or has product limitations.

In some examples, the determining that the current configuration of the computing device omits the functionality occurs after providing a resolution action for the issue with the computing device. That is, there can be a call topic prediction mechanism that identifies the user's issue and provides at least one resolution step. It can be determined that none of the available resolutions resolve the specific user case due to missing functionality or product limitations with the computer.

In some examples, the product (of operation 508) is a first product, and the computing device omitting the functionality comprises the computing device comprising a product limitation with a second product that is installed on the computing device. That is, there can be a product limitation of an existing product installed on the computer.

After operation 506, process flow 500 moves to operation 508.

Operation 508 depicts providing information about the functionality to a data store that comprises identifications of functionalities, to produce an identifier of a product that comprises the functionality, wherein the current configuration of the computing device omits the product, and wherein the computing device is determined to be able to install the product. The data store can be similar to functionalities 216 and/or functionalities 222 of FIG. 2.

In some examples, the product that comprises the functionality is associated with a vendor, and the vendor is associated with the computing device. That is, the product can be part of a direct offering.

In some examples, the product that comprises the functionality is associated with a first vendor, wherein the computing device is associated with a second vendor, and the first vendor and the second vendor differ. That is, the product can be part of a channel offering.

After operation 508, process flow 500 moves to operation 510.

Operation 510 depicts storing the identifier of the product that comprises the functionality. That is, where a product is identified in operation 510, this product name can be stored, so as to be referenced in the future.

After operation 510, process flow 500 moves to operation 512.

Operation 512 depicts initiating installation of the product to the computing device. This can comprise looping in a sales agent during the in-call phase, and/or indicating to the sales agent to contact the user at a later time, after the in-call phase of the support call ends.

After operation 512, process flow 500 moves to 514, where process flow 500 ends.

FIG. 6 illustrates another example process flow 600 that can facilitate product offering based on a support call, in accordance with an embodiment of this disclosure. In some examples, one or more embodiments of process flow 600 can be implemented by product offering based on a support call component 108 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts identifying a problem with a computer. In some examples, operation 604 can be implemented in a similar manner as operation 504 of FIG. 5.

After operation 604, process flow 600 moves to operation 606.

Operation 606 depicts determining that a current configuration of the computer omits a functionality, which prevents fixing the problem with the computer while using the current configuration of the computer. In some examples, operation 606 can be implemented in a similar manner as operation 506 of FIG. 5.

After operation 606, process flow 600 moves to operation 608.

Operation 608 depicts inputting information about the functionality to a data store that comprises identifications of functionalities, resulting in an output from the data store comprising an identifier of a module that comprises the functionality, wherein the current configuration of the computer omits the module, and wherein the computer is capable of having the module installed. In some examples, operation 608 can be implemented in a similar manner as operation 508 of FIG. 5.

After operation 608, process flow 600 moves to operation 610.

Operation 610 depicts storing the identifier of the module that comprises the functionality. In some examples, operation 610 can be implemented in a similar manner as operation 510 of FIG. 5.

After operation 610, process flow 600 moves to 612, where process flow 600 ends.

FIG. 7 illustrates another example process flow 700 that can facilitate product offering based on a support call, in accordance with an embodiment of this disclosure. In some examples, one or more embodiments of process flow 700 can be implemented by product offering based on a support call component 108 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts identifying a defined metric regarding functionality. That is, where multiple modules have a given functionality, a module to recommend to the user can be identified according to a particular metric.

In some examples. the defined metric is based on a suitable-solution criterion representative of a threshold suitability to solve the problem using the module. In some examples, the defined metric is based on a profitability criterion representative of a threshold profitability to solve the problem using the module.

In some examples, the computer is associated with a first vendor, a first module of the group of modules is offered by the first vendor, and a second module of the group of modules is offered by a second vendor.

In some examples, the identifying of the problem with the computer occurs during an in-call phase of support for the computer, and the identifying of the problem with the computer is performed based on determining at least one relevant prediction of the problem during the in-call phase in accordance with a defined relevancy criterion. Using the example of FIG. 2, the in-call phase can be in-call phase 204, and the relevant prediction can be relevant predictions from issue(s) prediction 202.

After operation 704, process flow 700 moves to operation 706.

Operation 706 depicts selecting the module from a group of modules, wherein respective modules of the group of modules comprise the functionality, and wherein the selection is performed based on the defined metric being determined to be satisfied by the module.

In some examples, operations 704-706 can be combined to comprise, the output comprising the identifier of the module that comprises the functionality comprises a selection of the module from a group of modules, wherein respective modules of the group of modules comprise the functionality, and wherein the selection is performed based on a defined metric being determined to be satisfied by the module.

After operation 706, process flow 700 moves to 708, where process flow 700 ends.

FIG. 8 illustrates another example process flow 800 that can facilitate product offering based on a support call, in accordance with an embodiment of this disclosure. In some examples, one or more embodiments of process flow 800 can be implemented by product offering based on a support call component 108 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts identifying an issue with computing equipment. In some examples, operation 804 can be implemented in a similar manner as operation 504 of FIG. 5.

After operation 804, process flow 800 moves to operation 806.

Operation 806 depicts determining that a current configuration of the computing equipment omits a functionality that is able to fix the issue with the computing equipment using the current configuration of the computing equipment. In some examples, operation 806 can be implemented in a similar manner as operation 506 of FIG. 5.

After operation 806, process flow 800 moves to operation 808.

Operation 808 depicts, based on information about the functionality, querying a data store that comprises identifications of functionalities, resulting in return of an identifier of a product that comprises the functionality, wherein the current configuration of the computing equipment omits the product, and wherein the computing equipment is configured to be able to install the product. In some examples, operation 808 can be implemented in a similar manner as operation 508 of FIG. 5.

In some examples, the computing equipment is associated with a vendor, and the product that comprises the functionality comprises a direct offering of the vendor, or a channel offering of the vendor. The direct offering can be similar to vendor offerings (direct) 214 of FIG. 2, and the channel offering can be similar to vendor offerings (channel) 220.

In some examples, operation 808 comprises offering the product to an entity via a device associated with the entity, wherein the entity initiated a support call regarding the issue with the computing equipment. This can be similar to deliver resolution 232 of FIG. 2.

In some examples, the product comprises a group of functionalities that comprises the functionality. This can be similar to the multiple functionalities per product illustrated with respect to FIG. 3.

After operation 808, process flow 800 moves to 810, where process flow 800 ends.

FIG. 9 illustrates another example process flow 900 that can facilitate product offering based on a support call, in accordance with an embodiment of this disclosure. In some examples, one or more embodiments of process flow 900 can be implemented by product offering based on a support call component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

In some examples where process flow 900 is implemented in conjunction with process flow 800 of FIG. 8, the product is a first product, the functionality is a first functionality, the issue is a first issue, the computing equipment is first computing equipment, and process flow 900 comprises based on determining that a second product comprises second functionality that addresses a second issue with second computing equipment, and based on determining that the second product is not offered, or is made inaccessible, by the vendor, refraining from offering the second product.

Operation 904 depicts determining that a second product comprises second functionality that addresses a second issue with second computing equipment. This can be similar to the Yes branch of missing functionality required for resolution? 212 of FIG. 2.

After operation 904, process flow 900 moves to operation 906.

Operation 906 depicts determining that the second product is not offered, or is made inaccessible, by the vendor. This can be similar to the No branch of functionality offered by vendor (channel)? 226 of FIG. 2.

After operation 906, process flow 900 moves to operation 908.

Operation 908 depicts refraining from offering the second product. This can be similar to lost upsell opportunity 224 of FIG. 2.

After operation 908, process flow 900 moves to 910, where process flow 900 ends.

FIG. 10 illustrates another example process flow 1000 that can facilitate product offering based on a support call, in accordance with an embodiment of this disclosure. In some examples, one or more embodiments of process flow 1000 can be implemented by product offering based on a support call component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

In some examples where process flow 1000 is implemented in conjunction with process flow 800 of FIG. 8, the product is a first product, the functionality is a first functionality, the issue is a first issue, the computing equipment is first computing equipment, and process flow 1000 comprises, based on determining that a second issue with second computing equipment is able to be resolved without addressing a second functionality that is omitted from the second computing equipment, refraining from offering a second product that corresponds to the second issue.

Operation 1004 depicts determining that a second issue with second computing equipment is able to be resolved without addressing a second functionality that is omitted from the second computing equipment. This can be similar to the No branch of missing functionality required for resolution? 212 of FIG. 2.

After operation 1004, process flow 1000 moves to operation 1006.

Operation 1006 depicts refraining from offering a second product that corresponds to the second issue. This can be similar to deliver resolution 232 of FIG. 2, flowing directly from missing functionality required for resolution? 212 of FIG. 2.

After operation 1006, process flow 1000 moves to 1008, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of service computer system 102, user computer system 106, and/or sales computer system 112.

In some examples, computing environment 1100 can implement one or more embodiments of the process flows of FIGS. 5-10 to facilitate product offering based on a support call.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the . NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ) , smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
at least one processor; and
at least one memory that stores executable instructions that, when executed by the at least one processor, facilitate performance of operations, comprising:
identifying, via a support agent device, an issue with a computing device based on support call data obtained during a support call;
determining, via the support agent device, that a current configuration of the computing device omits a functionality, which prevents fixing the issue with the computing device using the current configuration of the computing device;
querying via the support agent device, a functionalities database with a query about the functionality, wherein the functionalities database comprises identifications of functionalities, to produce an identifier of a product that comprises the functionality, wherein the current configuration of the computing device omits the product, and wherein the computing device is determined to be able to install the product;
based on the identifying of the product, connecting, via the support agent device, a sales agent device to the support call, wherein the sales agent device has access to information regarding the product that is unavailable to the support agent device;
and
based on the connecting of the sales agent device to the support call, initiating installation of the product to the computing device.

2. The system of claim 1, wherein the product is a first product, and wherein the computing device omitting the functionality comprises the computing device comprising a product limitation with a second product that is installed on the computing device.

3. (canceled)

4. The system of claim 1, wherein the making of the correction data indicative of the product that comprises the functionality available to the user device occurs during the support call.

5. The system of claim 1, wherein the making of the data indicative of the product that comprises the functionality available to the user device occurs in a separate process that occurs in parallel to the support call.

6. The system of claim 1, wherein the determining that the current configuration of the computing device omits the functionality occurs after providing a resolution action for the issue with the computing device.

7. The system of claim 1, wherein the product that comprises the functionality is associated with a vendor, and wherein the vendor is associated with the computing device.

8. The system of claim 1, wherein the product that comprises the functionality is associated with a first vendor, wherein the computing device is associated with a second vendor, and wherein the first vendor and the second vendor differ.

9. A method, comprising:
identifying, by a system comprising at least one processor, a problem with a computer;
determining, by the system, that a current configuration of the computer omits a functionality, which prevents fixing the problem with the computer while using the current configuration of the computer;
querying, by the system, a data store with a query about the functionality, wherein the data store comprises identifications of functionalities, resulting in an output from the data store comprising an identifier of a module that comprises the functionality, wherein the current configuration of the computer omits the module, and wherein the computer is capable of having the module installed;
based on the identifier of the module, connecting, via the system, a sales agent device to the support call, wherein the sales agent device has access to information regarding the product that is unavailable to the system;
based on the connecting of the sales agent device to the support call, initiating, by the system, installation of the product to the computing device.

10. The method of claim 9, wherein the output comprising the identifier of the module that comprises the functionality comprises a selection of the module from a group of modules, wherein respective modules of the group of modules comprise the functionality, and wherein the selection is performed based on a defined metric being determined to be satisfied by the module.

11. The method of claim 10, wherein the defined metric is based on a suitable-solution criterion representative of a threshold suitability to solve the problem using the module.

12. The method of claim 10, wherein the defined metric is based on a profitability criterion representative of a threshold profitability to solve the problem using the module.

13. The method of claim 10, wherein the computer is associated with a first vendor, wherein a first module of the group of modules is offered by the first vendor, and wherein a second module of the group of modules is offered by a second vendor.

14. The method of claim 10, wherein the identifying of the problem with the computer occurs during an in-call phase of support for the computer, and wherein the identifying of the problem with the computer is performed based on determining at least one relevant prediction of the problem during the in-call phase in accordance with a defined relevancy criterion.

15. A non-transitory computer-readable medium comprising instructions that, in response to execution, cause a system comprising at least one processor to perform operations, comprising:
identifying an issue with computing equipment;
determining that a current configuration of the computing equipment omits a functionality that is able to fix the issue with the computing equipment using the current configuration of the computing equipment;
querying a data store with information about the functionality, wherein the data store comprises identifications of functionalities, resulting in return of an identifier of a product that comprises the functionality, wherein the current configuration of the computing equipment omits the product, and wherein the computing equipment is configured to be able to install the product.

16. The non-transitory computer-readable medium of claim 15, wherein the computing equipment is associated with a vendor, and wherein the product that comprises the functionality comprises a direct offering of the vendor, or a channel offering of the vendor.

17. The non-transitory computer-readable medium of claim 16, wherein the operations further comprise:
offering the product to an entity via a device associated with the entity, wherein the entity initiated a support call regarding the issue with the computing equipment.

18. The non-transitory computer-readable medium of claim 17, wherein the product is a first product, wherein the functionality is a first functionality, wherein the issue is a first issue, wherein the computing equipment is first computing equipment, and wherein the operations further comprise:
based on determining that a second product comprises second functionality that addresses a second issue with second computing equipment, and based on determining that the second product is not offered, or is made inaccessible, by the vendor, refraining from offering the second product.

19. The non-transitory computing equipment-readable medium of claim 17, wherein the product is a first product, wherein the functionality is a first functionality, wherein the issue is a first issue, wherein the computing equipment is first computing equipment, and wherein the operations further comprise:
based on determining that a second issue with second computing equipment is able to be resolved without addressing a second functionality that is omitted from the second computing equipment, refraining from offering a second product that corresponds to the second issue.

20. The non-transitory computer-readable medium of claim 17, wherein the product comprises a group of functionalities that comprises the functionality.

21. The non-transitory computer-readable medium of claim 15, wherein the product is a first product, and wherein the computing device omitting the functionality comprises the computing device comprising a product limitation with a second product that is installed on the computing device.
